(19) United States
(12) Patent Application Publication
(10) Pub. No.: US 2024/0073202 A1
(43) Pub. Date: Feb. 29, 2024

(54) METHODS AND APPARATUS TO PROVE ACCESS AND IDENTITY

(71) Applicant: Timothy Lee McLaughlin, Vienna, VA (US)

(72) Inventor: Timothy Lee McLaughlin, Vienna, VA (US)

(21) Appl. No.: 18/210,058

(22) Filed: Jun. 14, 2023

Related U.S. Application Data
(60) Provisional application No. 63/352,507, filed on Jun. 15, 2022.

(51) Int. Cl. H04L 9/40

(52) U.S. Cl. CPC H04L 63/0838

(57) ABSTRACT

Provided herein is a method that can verify a user identifying address by more efficient means than previously achieved in situations where the user compute device which is communicating with the application is also capable of sending messages to the application from the user address needing to be verified. This allows the application to determine user validity and identity and, if needed, message the user using the verified user address in subsequent communications.

### CROSS-REFERENCE TO RELATED APPLICATIONS

This application claims priority from U.S. Provisional Patent Application 63/352,507, filed on Jun. 15, 2022, all of which is hereby incorporated by reference in its entirety.

### BACKGROUND

Many websites and applications such as Facebook, LinkedIn, Amazon, etc. (hereafter referred to as “applications”) require that a user using a compute device provide at least one unique identifier/address such as a phone/SMS number, WhatsApp number, email address, Twitter handle, or similar address (“user address”) to allow private two way communication in order to enable the application to: 1) communicate with the user at the user address using phone, SMS, email, message, or other communication methods appropriate for said address and 2) store the user's application information in such a way that it is useful to the user who is the owner of the user address.

In order for applications to confirm that a user owns an address, the application needs to verify the user's “proof of control” of that address by sending a message to the user provided address containing a unique value as either a one time password (OTP) or a unique URL.

After receiving the message at the user provided address, the user can prove control of the user address by supplying the OTP received therein to the application through a user interface or by visiting the unique URL in the message respectively.

The aforementioned methods require multiple users steps which can be difficult and/or error prone, incur costs to the application owner for the sending of the verification message, and/or result in messages being sent to an address which is not owned by the user due to the user entering the wrong address either intentionally or unintentionally.

OTP is more complex for the user than just clicking a unique link in the message since the user needs to enter a unique sequence of digits or letters into a user interface, but OTP is often preferred because it more easily allows for the OTP message to be received on a compute device different from the compute device using the application (eg. using a computer with the application and a mobile phone for SMS messaging).

### SUMMARY OF THE INVENTION

One or more embodiments discussed herein can improve upon prior methods for OTP transmission by optimizing for situations when the user is using the application and messaging on the same compute device (e.g., a smartphone). In an example embodiment, an application can be provided that is capable of receiving messages directly from the user at an application provided address (“application address”).

Given those capabilities, one embodiment works by having the user send the OTP to the application rather than the other way around. In order to do so efficiently, the application supplies a user interface which allows the user to conveniently easily send a message using their messaging application containing an OTP to the application address by clicking a link, button, etc. and no further effort.

For example, the embodied processes can eliminate:
the need for the user to enter their user address (e.g., a phone/SMS number, email address, etc.),
the need for the user to wait for and view the message containing the OTP in a separate messaging application,
the need for the user to manually enter the OTP which they receive into a application provided user interface,
the costs for the application to send a message to the user,
the sending of OTP messages to addresses other than the user due to accidental or malicious entry of the wrong user address by the user, and/or
any jurisdictional, technical, and legal complexities often intended to block spamming of users by applications.

The embodiments do not improve upon traditional OTP verification methods when messages are received on a device which is different from the compute device which is using the application.

### BRIEF DESCRIPTION OF DRAWINGS

The accompanying drawings, which are incorporated and constitute a part of this specification, illustrate an embodiment of the invention. In the drawings,

FIG. 1 illustrates user, user compute device, and application compute device interactions; and

FIG. 2 illustrates an example of a method for verifying a user address is owned by a user by requiring the user send (not receive) a message containing a one time password (OTP) from the user address which they intend to verify.

### DETAILED DESCRIPTION

The following detailed description refers to the accompanying drawings. The same reference numbers in different drawings may identify the same or similar elements. Also, the following detailed description describes embodiments of the invention and is not intended to limit the invention. Instead, the scope of the invention is defined by the appended claims and equivalents.

### A. Overview

In an embodiment described herein an example method can include when an application is being used on a compute device and said application needs to confirm ownership of an address by a user.

As used herein, the term “application” is intended to include, for example, any website or application (e.g., USPTO.gov, Facebook, LinkedIn, Amazon, etc.) which uses addresses provided by users.

As used herein, the term “address” is intended to include, for example, any series of characters used to identify the sender and recipient of a message within a messaging system. Examples include phone/SMS numbers (+1-555-555-5555), email addresses (joe@doe.com), Twitter handles (@elonmusk), etc. Addresses frequently have a required syntax (eg. email addresses cannot contain space and must contain one @ character and at least one “.” character).

User address, as used herein, is the address which is owned by the user.

As used herein, the term “application address” is intended to include, for example, the address which is owned by the application.

As used herein, the term “messaging” is intended to include, for example, any sort of method for delivering a private message from a user address to an application address. Examples include email, phone, SMS, WhatsApp, Twitter Direct Messages, etc.

As used herein, the term “messaging application” is intended to include, for example, any application used for sending and receiving messages (e.g., Microsoft Outlook®, iMessage®, Messages, WhatsApp®, Gmail®, etc.).

As used herein, the term “compute device” is intended to include, for example, computers, smart phones, etc. with a processor, memory, and a display or the like. Compute devices can communicate with other compute devices using networks, quick response (QR) codes, radio waves, etc. Compute devices can be personal devices, such as phones, but can also be local devices that can be accessed using secure and individualized identifiers, such as a device that is connected to a local access network, for example, that can be used to correlate information as needed.

“Compute devices” can include “application compute devices,” “user compute devices,” or other compute devices as needed to accomplish the example embodiments.

“Application system” can include software and/or on compute device(s) such as web server(s), applications server(s), network of servers, etc. providing access to users using user compute devices and/or application compute devices through the Internet that is also addressable via messaging systems such as email, SMS, WhatsApp, etc. Application system can include any type of application compute device(s).

### B. Embodiments

Embodiments disclosed herein are intended as examples that can be used to implement the claims. Limitations to the embodiments are not intended to limit the scope of the claims, but rather as examples to explain possible options in the claims.

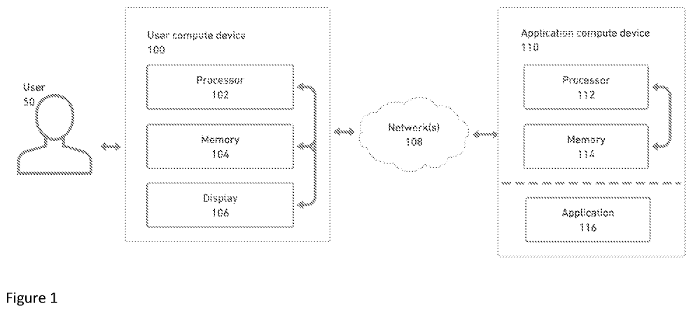

As disclosed herein, FIG. 1 illustrates one embodiment for verifying an address for a user using a compute device which is using network(s) to communicate with an application on an application compute device.

As illustrated in FIG. 1, an example of method for an application 116 to verify that user 50 is the owner of a user address using user compute device 100 to communicate using network(s) 108 with application compute device 110 thereafter allowing for the verified user address to be used as an identifier and/or address by said application 116. As shown in FIG. 1, user 50 interacts with application 116 on application compute device 110 using a user interface on user compute device 100. Communication between user compute device 100 and application compute device 110 can occur using wired or wireless networks such as the Internet, SMS networks, radio frequency similar, but not limited to Bluetooth, etc.

User compute device 100, which can be a compute device or the like, can include processor 102, memory 104, and display 106. Application compute device 110, which can be a compute device or the like, can include processor 102 and memory 104 and can interface with user 50 through user interfaces provided on user compute device 100.

In the methods described below, each step is optional, but provided for explanation of options available in the example method.

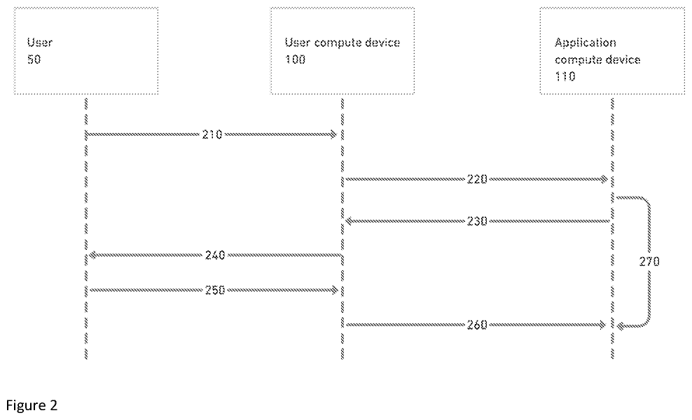

As illustrated in FIG. 2, an example of a method for verifying a user address is owned by a user by requiring the user send (not receive) a message containing a one time password (OTP) from the user address which they intend to verify.

FIG. 2 illustrates a sequence of steps for verifying the card. Step 210 begins when user 50 uses user compute device 100 to start the process. User compute device 100 can request the OTP and application address from application compute device 110 in step 220 which are returned to user compute device 100 in step 230 and presented to user 50 in step 240.

In step 250, user 50 then can use user compute device 100 to send a message to the application address containing the OTP in step 260.

In step 270, application compute device 110 can then compare the OTP contained in the message to the OTP that was provided in step 230 to determine whether to verify the authenticity of user 50. If they match, then user 50's authenticity is verified. If they do not, then user 50 is not verified.

In some implementations, application compute device 110 can be configured to verify that user 50 is directly or indirectly associated with user compute device 100 which can access (e.g., is authorized to access, is capable of accessing, etc.) a secondary communication channel (e.g., email or SMS), and user 50 can use user compute device 100 to prove authority to access, has actual or virtual access, or has capability to access, etc. to an address on that channel (e.g., tim@example.com or +1-555-222-2323) for identity, access control, and/or messaging purposes.

User 50 can initiate a verification process to authenticate or verify user 50 on user compute device 100 through some action on user compute device 100 (e.g., clicking a button in a browser or application, starting an application, a voice command, or other available action). The action can be positively initiated or in response to a prompt depending on the process desired.

User compute device 100 can identify itself for verification to application compute device 110 using, for example, a web browser cookie, unique identifier in the URL, unique identifier in the page, International Mobile Equipment Identity (IMEI), and/or any other identifier.

The user compute device 100 can compute and/or determine in coordination with the application compute device 110 a time sensitive unique OTP (e.g., 123456789) and a application address (e.g., SMS number such as +1-571-555-5454) for the message. The user compute device address (e.g., smartphone identifier) can be included in the message or associated with the OTP stored in memory 114 of the application compute device 110.

The user compute device 100 can combine all parts of the above data into a URL (e.g., “sms: +1-571-555-5454& Verify %20m %20phone %3A %20123456789.”), and opens that URL to initiate a message from their messaging app on the user compute device 100 including the OTP which would appear to the user 50 as in their messaging app:
From: +1-571-222-2323 (implicitly set by the smartphone's phone number)
To: +1-571-555-5454
Message: Verify my phone: 123456789.

The application compute device 110 receives the message via email or SMS from the user compute device 100 and determines if the OTP is valid based on time and value.

If the OTP is valid, then the application compute device 110 can associate the sender address (e.g., +1-571-222-2323) with the user's profile on the application compute device 110 for future use when confirming identity, merging profiles, access control, profile data, and/or messaging purposes.

In one example, a user interface (“UI”) can be provided to a consumer who is browsing a website of a restaurant using the user compute device 100, and the application compute device 110 is associated with (e.g., is used by or accessed by) the restaurant. The user UI can indicate on the website of the restaurant via application compute device 110 that the user UI would like to order a menu item, and the restaurant and/or application compute device 110 would like to verify that the user 50 is allowed to order the menu item. The user compute device 100 can generate a message at a messaging app on the user compute device 100 and including an OTP without receiving input from the user (e.g., a phone number, an email address, etc.), and send the message to the application compute device 110. The application compute device 110 can determine that the OTP is valid, and as a result, determine that the user UI is allowed to (e.g., pre-initiate verification (in an application or a browser)).

In one example, a user interface (“UI”) can be provided to a consumer who is using an application of a business using the user compute device 100, and the application compute device 110 is associated with business (eg. Bank of America). The user UI can indicate on the UI of the bank via the application compute device 110 that the user 50 needs verify that the user 50 is an employee of the bank. The user compute device 100 can generate a message using a messaging app on the user compute device 100 and including an OTP without receiving input from the user (e.g. tim@bankofamerica.com), and send the message to the application compute device 110. The application compute device 110 can determine that the OTP is valid, the user email address is owned by the business (eg. @bankofamerica.com), and as a result, permit that the user is allowed to access private portions of the application.

While the invention has been described in detail with reference to preferred embodiments thereof, it will be apparent to those skilled in the art that variations and modifications can be made, and equivalents employed without departing from the scope of the appended claims.

AI definitions, as defined and used herein, should be understood to control over dictionary definitions, definitions in documents incorporated by reference, and/or ordinary meanings of the defined terms.

Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and development tools. Additional examples of computer code include, but are not limited to, control signals, encrypted code, and compressed code.

The drawings primarily are for illustrative purposes and are not intended to limit the scope
of the subject matter described herein. The drawings are not necessarily to scale; in some instances, various aspects of the subject matter disclosed herein can be shown exaggerated or enlarged in the drawings to facilitate an understanding of different features. In the drawings, like

7
Attorney Docket No. GOTA-002/0005 333300-2002
reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of.” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code can be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C+, Java™M, Ruby, Visual Basic™M, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C+, etc.) or other suitable programming languages and/or development tools. Additional examples of computer code include, but are not limited to, control signals, encrypted code, and compressed code.

1. A method, comprising:
receiving, via a processor included in a first compute device, from a user, and at a browser application, a request to initiate a verification process;
sending, via the processor, to a second compute device, in response to receiving the request to initiate the verification process, and without requiring input from the user, a request for a verification code;
receiving, via the processor and from the second compute device, the verification code;
generating, via the processor, at a messaging application, and without requiring input from the user, a message including the verification code, an identifier associated with the first compute device, and a destination address associated with the second compute device; and
sending, via the processor and using the destination address, a signal representing the message to the second compute device, the second compute device configured to (1) verify the OTP in response to receiving the signal, and (2) associate the identifier with the first compute device in response to verifying the verification code.

2. A method, comprising:
receiving, via a processor included in a first compute device and from a second compute device associated with a user, a request for a verification code;
sending, via the processor and to the second compute device, the verification code; receiving, via the processor, a message including the verification code and an identifier of the second compute device;
associating, via the processor, the identifier of the second compute device with a profile associated with the user, receiving, via the processor and from the second compute device, a request to access a limited service; and
determining, via the processor and based on the profile, that the second compute device is authorized to access the limited service without requiring the user to provide the identifier of the second compute device.

3. A system, comprising:
a processor that creates an OTP;
sending the OTP to the user compute device;
confirms that the OTP received via message is correct to verify.
